(19) United States
(12) Patent Application Publication
(10) Pub. No.: US 2009/0280671 A1
(43) Pub. Date: Nov. 12, 2009

(54) Electrical plug and socket harness-deflector

(76) Inventor: Richard Martin Kierstead, Van (CA)

Correspondence Address: RICHARD M. KIERSTEAD, #102 8410 ONTARIO ST., VANCOUVER,, BC, V5X456, CA

(21) Appl. No.: 12/387,219

(22) Filed: Apr. 28, 2009

Related U.S. Application Data
(60) Provisional application No. 61/126,535, filed on May 6, 2008.

(51) Int. Cl. H01R 4/50

(52) U.S. Cl. 439/346

(57) ABSTRACT

A snap on device to harness an electrical plug and socket connection with the ability to deflect it around corners and snags and maintain the connection when cords are pulled or dragged.

### CROSS-REFERENCE TO RELATED APPLICATIONS

This application claims benefit of provisional patent application Ser. No. 61/126,535, filed May 6, 2008 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to devices used to prevent accidental disconnection of electrical plug and socket connections attached to conductor cords, and deflection of same connections when cords are being pulled or dragged, such as when working with powertools.

2. Prior Art

The trades and people working on home improvements and home maintenance commonly use power tools plugged into electrical extension cords for many purposes. When being pulled or dragged the electrical plug and socket connection regularly comes apart, snags or both. Knots are tied in electrical cords to prevent disconnection, but this is very hard on the cords and increases snagging. Various retaining devices have been proposed to alleviate this nuisance but none have achieved the full potential possible. For example, U.S. Pat. No. 4,643,505 House; David N—Sauseda; Blaso. Feb. 17, 1987. This proposal encapsulates the whole electrical connection, but is complicated with multiple parts and is slow to apply. If one were to step on it on the floor, due to its hard plastic nature, it would most probably slide and possibly result in injury.

Another proposal is U.S. Pat. No. 4,183,603 Donarummo; Robert Jun. 9, 1978. In this example pressure is only applied from one side of the connection, therefore requiring the device to be reinforced by a rigid strip contained within it, seriously complicating manufacture and limiting it's use on electrical plug and socket connections that do not fit the limited length capability of this device. Furthermore, the device does not have any deflective capability and would be prone to snagging resulting in extreme forces coming to bear on the device and attached electrical cords. This is not only extremely irritating but very dangerous. If for instance you were using a large router with a large digging bit and the device snagged, the resulting uneven pressures can cause the router to jump wildly causing damage to the material being worked on and possibly seriously injuring to the operator of the router. These deficiencies are common in relevent prior art and none have the combined qualities and advantages possible, especially ease of use and safety.

3. Objects and Advantages

This plug harness and deflector is easily applied in seconds, is streamlined and compact, smoothly deflects around and over snags and effectively retains an electrical plug and socket connection. It is non-slip when stepped on and absorbs shock when kicked. Connection retaining pressure is applied to the shoulders of the plug and socket so there is no damage to the electrical cords. It will harness an extra large plug and socket connection like the replacement variety. This harness-deflector has been tested in my millwork shop and other shops for approximately two years and has become an indispensible tool for people who use electrical extension cords regularly. Further objects and advantages will become apparent from specifications and drawings.

### SUMMARY

This invention is a one piece elastic device made in a multiple part injection type mould. It is used with electrical cords attached to a plug and socket connection. The device does not require any tools to apply and is quickly applied by hand to harness, deflect and maintain an electrical plug and socket connection when cords are pulled or dragged in either direction.

### DRAWINGS—FIGURES

FIG. 1 is a perspective view of the open side of the plug harness attached to electrical cords and plug and socket connection.

FIG. 2 Is an end view of the small end of one of the tapered end parts showing the tapered detent slot and recess.

FIG. 3 is a view of the large end of one of the tapered end parts showing the tapered detent slot and recess, bands crossection, and flat area that puts pressure on the shoulders of the electrical plug or socket.

### DRAWINGS—REFERENCE NUMERALS

12 and 14 tapered and semi-conical end parts with open faces

16 and 18 connecting bands

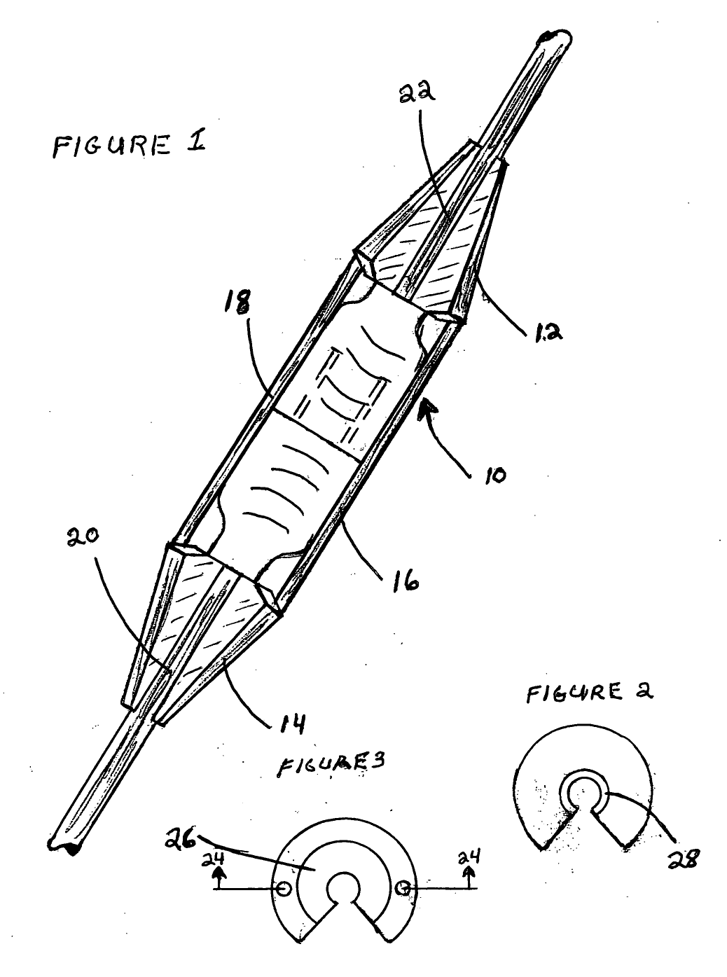

20 and 22 detent slots with recesses (recesses shown with electrical cords in FIG. 1)

24 crossection view

26 view of surface area of pressure point at inside ends of parts 12 and 14

28 end view of small outside end of parts 12 and 14

### DETAILED DESCRIPTION

The harness-deflector is an elastic device that is designed to be attached to electrical cords with a plug and socket connection between. Both ends are designed to snap onto cords while squeezing the connection between, retaining the connection. The tapered and somewhat conical ends deflect the harnessed connection around and over corners and snags when pulled or dragged. This harness-deflector is a one piece moulded device made of flexible elastic material.

The drawings depict the preferred embodiment of the harness-deflector with two identical ends 12 and 14 connected by bands 16 and 18. Ends 12 and 14 have tapered, graduated slots with recesses 20 and 22 for retention of electrical cords with plug and socket attached. The connected plug and socket are squeezed between ends 12 and 14. It should be known that the configuration of these ends can vary, (an example of this is by having reliefs or a skeletal shape to save on elastic material or vary strength) as long as tapered slots and recesses 20 and 22 are provided therein and deflective qualities remain. Also it should be known that either end 12 or 14 could be replaced by an attached socket or vary as long as one end is the same as 12 or 14. The connecting bands 16 and 18 are round in this embodiment (crossection no. 24), but can be of another shape or number. Surface area of ends 12 and 14 where pressure is exerted to squeeze connection is depicted by no. 26. Small ends of 12 and 14 are depicted by no. 28.

### Operation

To operate one snaps one end 12 on the electrical cord on one side of the plug and socket connection then stretches the other end 14 over the connection and snaps it on to the electrical cord on the other side of the connection. This acts as a harness, retaining the plug and socket connection by applying pressure on the outside ends of the connection, and not pulling on the electrical cords. This application takes only seconds, especially when leaving the device attached to one of the cords, usually the extension cord. After plugging in to the extension cord socket, it takes only a pull and a snap motion to apply the device, effectively harnessing the electrical plug and socket connection.

The tapered and somewhat conical shaped ends of the harness 12, 14 smoothly deflect the plug and socket connection around or over corners and snags when being dragged or pulled such as when operating power tools. Plugs getting caught or snagged can be extremely dangerous and damaging, for example when operating a skill saw, snagging can cause the blade to twist in the cut and the saw to jump and travel dangerously out of control. This can result in serious personal injury and expensive material damage.

The harness-deflector has no rigid parts to break or slide when impacted or stepped on. Being made of elastic material it has the ability to both stretch and absorb shock. One is less likely to trip on it or attached cords. It does not distort or mishape conductor cords by crimping, wedging, bending or pressure.

I claim:

1. A one piece elastic device used to maintain and deflect a plug and socket connection attached to electrical cords, comprising:
(a) two tapered end parts with open faces to accept said electrical cords in detent stops, with said plug and socket connection harnessed between said tapered end parts,
(b) said tapered end parts (a) are connected by a plurality of lines or bands which when stretched over said plug and socket connection bring pressure on outside ends of said plug and socket connection at the inside ends of said tapered end parts helping to maintain said plug and socket connection,
(c) said tapered end parts (a) have the small ends of the taper at the outside ends of said elastic device, helping to deflect said plug and socket connection when being pulled or dragged either way by said electrical cords,
whereby said device, being made of an elastic material will stretch and absorb a strong shock is less likely to fall someone if they trip on the attached said electric cords, also said elastic device can be stepped on without said device sliding and causing a fall or strain.
